(19) United States
(12) Patent Application Publication
(10) Pub. No.: US 2012/0170325 A1
(43) Pub. Date: Jul. 5, 2012

(54) High Efficiency Solar Wind Inverter With Hybrid DCDC Converter

(76) Inventors: Norman Luwei Jin, Rochester Hills, MI (US); Yimeng Jin, Rochester Hills, MI (US)

(21) Appl. No.: 12/983,262

(22) Filed: Dec. 31, 2010

(51) Int. Cl. H02M 5/45

(52) U.S. Cl. 363/21.09

(57) ABSTRACT

The present invention is a new design topology for solar/wind inverters using a new hybrid DC/DC converter design. This hybrid converter topology eliminates a difficult design compromise between lowering the minimum input voltage to harvest more solar/wind energy and achieving high power conversion efficiency when the input voltage is high in a conventional solar/wind inverter design. This invention uses both a forward converter and a flyback converter to deliver superior performance over a design that only uses one of the two converter topologies.

### BACKGROUND OF THE INVENTION

As global concern for the environment and energy sustainability grows, the prevalence of solar power, wind power and other renewable energy sources has increased correspondingly. Solar power systems take up a great portion of this prevalence. It is primarily comprised of two components: photovoltaic (PV) panels and a power inverter. The solar panel harvests light energy and converts it into DC power which an inverter subsequently converts to usable AC power. Within the inverter, there are again two main sub-circuits, a DC/DC converter followed by a full-bridge inverter. The first DC/DC voltage converter converts the input DC power from the solar panel to a DC voltage that can be used by the subsequent inverter. The second part is a DC/AC inverter that converts the DC output of the converter to AC power compatible to the power grid.

This invention is focused on the DC/DC converter that makes up the first half of the solar power inverter. The present invention was developed specifically for solar/wind micro-inverter systems, but the concept can be extended to string inverter, multiple string inverter and central inverter systems as well. For use in a solar/wind micro-inverter, this converter must raise the low output DC voltage from a solar module to the high voltage level of the power grid. The traditional design of this DC/DC converter uses a push-pull converter or a full bridge converter, a suitable choice of design for raising the low output voltage of a solar panel, providing a high power rating and high efficiency at low operating voltage (FIG. 1—Functional block diagram of a traditional DC/DC converter in a micro-inverter design). However, both the push-pull converter and the full bridge converter have a fixed maximum voltage boost ratio, determined by the turns ratio of the isolation transformer. How to properly choose the transformer's turns ratio is a major challenge in the converter design.

When the sun light intensity is low, such as at dawn or twilight or on cloudy days, all solar power will be lost, if the PV panel output voltage is below the required minimum operating voltage of the inverter. A transformer with higher secondary to primary turns ratio will lower the input voltage requirement of the push-pull DC/DC converter or the full bridge converter, since the converter's maximum output voltage is proportional to transformer's turns ratio. It seems that by raising the transformer's turns ratio, we could lower the minimum input voltage requirement and harvest more solar energy when the solar light intensity is not ideal.

On the other hand, a converter's output/input voltage ratio can also be altered by manipulating the power switching device's on-off duty cycle. For a fixed input voltage value and a fixed transformer's turns ratio, the forward DC/DC converter's output will reach its peak when the power switching device's duty cycle approaches 100%. To further raise the output voltage when the duty cycle is already close to 100%, the only available option is to increase the transformer's turns ratio. The statement is true for all forward type DC/DC converters.

A high transformer's turns ratio lowers the minimum input DC operating voltage from solar modules. With the high transformer's turns ratio, when a solar panel outputs low voltage, the DC/DC converter can yet output voltage high enough to make the subsequent inverter function. However, a high transformer's turns ratio will force the converter to reduce the power switching device's on-off duty cycle when the input voltage is at maximum, or otherwise, the output voltage would be too high for the subsequent inverter. That is to say, when the transformer's turns ratio is high, the switching device's duty cycle must be low when input voltage is high, if a constant output voltage is to be maintained. Constant output voltage is required in solar/wind inverter operations since output voltage should always be slightly higher than the grid line voltage which is stable in its rms value.

It is not desired to decrease the switching device's on-off duty cycle as it reduces the DC/DC converter's power efficiency. At the same power level, lower duty cycles yield higher peak switching currents for the same input voltage, although the average current from the power source remains the same. Higher peak switching currents cause larger power losses for the following reasons:
1) Higher peak switching currents cause higher conduction losses since the switching devices' conduction losses are proportional to the square of the switching current.
2) Higher switching currents cause higher switching losses as switching loss is proportional to the switching current.
3) Higher switching currents cause higher transformer power loss as the transformer's copper loss is proportional to the square of the switching current; magnetic core loss also rises quickly as core magnetic flux density, which is proportional to the switching current, increases.

### Mathematically,

Power=I*V*DC=I²*R*DC

where, I is the switching current, V is the switching voltage, DC is the duty cycle and R is the switching device's ON resistance plus equivalent transformer's serial resistance.

Note the above equation can be applied to both the power loss and the total output power. If we half the duty cycle, the peak current must be doubled to maintain the same output power level. The power loss actually doubled since power is proportional to both the duty cycle and the square of the current. In other words, when duty cycle decreases, the converter switching devices are only working a small portion of the time. To do the same amount of work, much high working intensity is needed. Therefore, a low duty cycle leads to higher switching current and higher peak current, which both lead to higher power loss. This explains why low duty cycles should be avoided if high power efficiency is desired.

Summarizing the relationship between the transformer's turns ratio and the power switching device's on-off duty cycle:
1. For a push-pull or a full bridge DC/DC converter (the most common converter in solar/wind micro-inverter design because solar module output voltage rarely exceeds 50 Vdc), the output voltage can be controlled by either manipulating the switching device's duty cycle or the transformer's turns ratio.
2. When the switching device's duty cycle approaches 100%, the output voltage reaches its peak, assuming constant transformer turns ratio.
3. To maintain the same output voltage while lowering minimum input voltage, higher transformer turns ratios are required.
4. Higher transformer turns ratios will force lower switching duty cycles during periods of high input voltage and thus lower power efficiency.

### SUMMARY OF THE INVENTION

It becomes apparent that a traditional push-pull or full bridge converter with a fixed transformer's turns ratio cannot meet the requirements that are asked of it. The dilemma in selecting the transformer's coil turns ratio in a push-pull or full bridge converter design is irresolvable. Higher turns ratios can lower required minimum input voltage, but will require lowering the duty cycle when input voltage is high to maintain constant output voltage, leading to poor efficiency. On the other hand, lowering the turns ratios will lead to insufficient voltage boosting from the converter, severely limiting the effectiveness of the inverter due to an early cut-off of the input voltage to the DC/DC converter. It seems that an inevitable compromise must be made in a conventional solar/wind micro-inverter design.

A new DC/DC converter topology is proposed in this invention to address the shortcomings of the conventional micro-inverter design. This new converter is actually a forward/flyback hybrid DC/DC converter, whose function block diagram is shown in FIG. 2.

FIG. 2 depicts the functional block diagram of the new hybrid converter micro-inverter design.

This hybrid converter is composed of an added flyback DC/DC converter in conjunction with a conventional push-pull converter. The output of the hybrid DC/DC converter is the current or voltage sum of the both converters' outputs (either in series or in parallel form). By employing this new hybrid converter, the push-pull converter can use a transformer with low turns ratio so that during normal conditions, the push-pull converter can work in high duty cycle mode to improve power efficiency. However, the input voltage from the DC sources will not always be constant. Different types of DC sources will output different voltages, and partial concealment of a panel by shadow will lower its output voltage in the case of solar modules. Thus, when the forward converter's transformer is incapable of boosting voltage sufficiently to feed the inverter, the flyback converter will kick in with its arbitrary voltage boost capability and ensure that the inverter always has the adequate voltage level to operate.

The additional converter is a flyback converter that stores the energy from the input DC power supply in its transformer when the switching device is on. The stored energy is released to the secondary coil and the load through a rectifier diode when the switching device is turned off. When the duty cycle of the flyback converter's switching device approaches 100%, the flyback output voltage and thus the total output voltage of the hybrid converter can be increased arbitrarily as required by the inverter, even if a solar photovoltaic panel's output voltage is very low.

The extra flyback converter will add some cost to the micro-inverter. The performance benefits in terms of power efficiency, wider maximum power point tracking (MPPT) input voltage range and low output current harmonic distortion can justify the added cost. In addition, the proposed hybrid converter design delivers extra power to the inverter section following the hybrid converter, hence lowering the power requirement of the push-pull converter. The existence of the second DC/DC converter and transformer can also spread the heat generated by switching devices and transformers over the circuit board, therefore reducing the circuit's hot spots and making a natural convection system cooling design easier.

### BEST MODE FOR CARRYING OUT THE INVENTION

Circuit design implementations of a solar micro-inverter with the invention have been proposed in FIG. 3 and FIG. 4.

FIG. 3 demonstrates a circuit topology of the new hybrid converter micro-inverter design with the power outputs of the forward and flyback DC/DC converters are connected in series to a DC voltage bus.

FIG. 4 depicts a circuit topology of the new hybrid converter micro-inverter design with the power outputs of the forward and flyback DC/DC converters are connected in parallel to a DC voltage bus.

In these micro-inverter designs, the push-pull converter used a transformer with a turns ratio of 10 and a flyback transformer with a turns ratio of 3.5. Optimally, the passive clamping circuit can be replaced by an active clamping circuitry to re-circulate the energy in the push-pull and flyback converters when the power switching devices are turned off, in order to further increase the power conversion efficiency. The active clamping/energy recirculation mechanism is beyond the scope of this invention, and it is not discussed here.

### BRIEF DESCRIPTION OF DRAWINGS

FIG. 1 is a functional block diagram of a traditional DC/DC converter in a micro-inverter design. The DC-DC converter can be of a push-pull or full-bridge design.

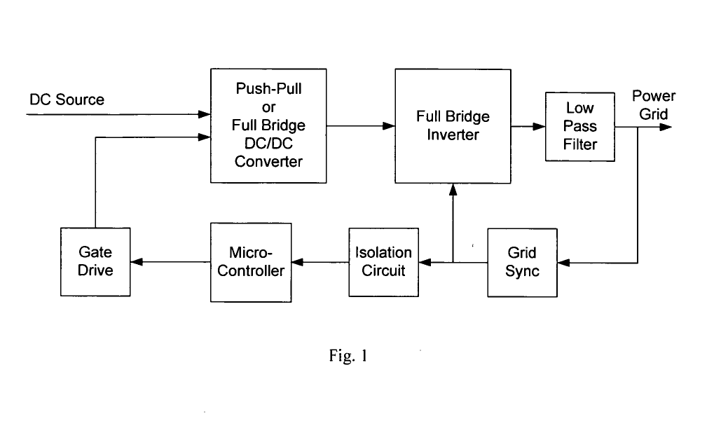

FIG. 2 is the functional block diagram of the present invention.

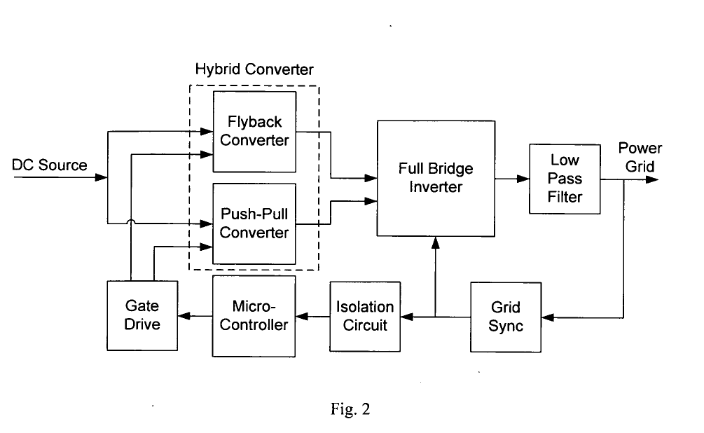

FIG. 3 is a circuit topology of the new hybrid converter micro-inverter design where the power outputs of the forward and flyback DC/DC converters are connected in series to a DC voltage bus.

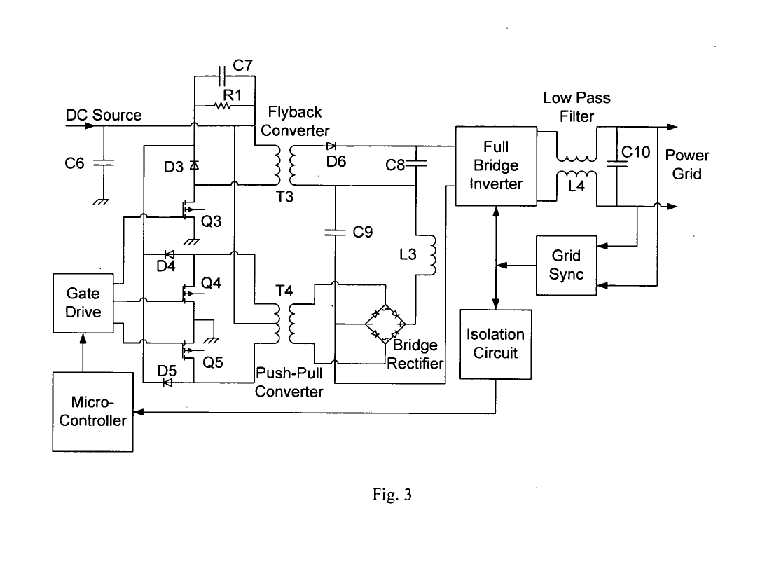

FIG. 4 is a circuit topology of the new hybrid converter micro-inverter design where the power outputs of the forward and flyback DC/DC converters are connected in parallel to a DC voltage bus.

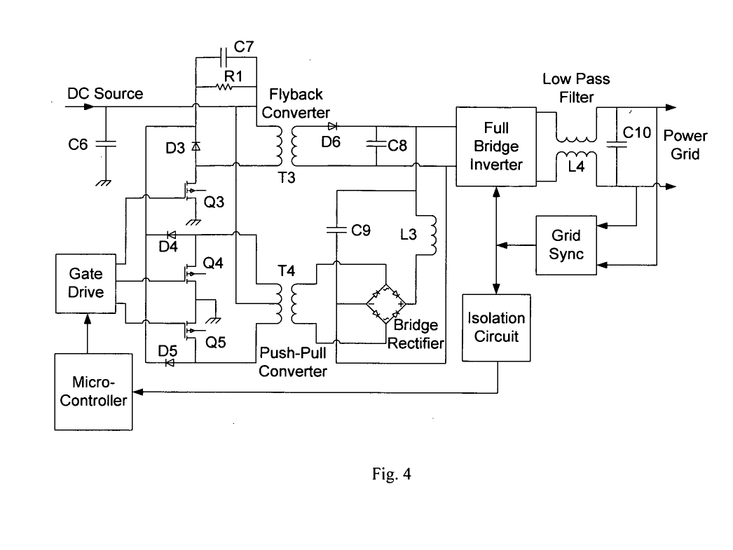

The invention claimed:

1) A hybrid DC/DC converter topology that includes both a forward converter and a flyback converter to achieve required output voltage, with the forward converter being in operation all the time whenever the hybrid DC/DC converter is on, and the flyback converter kicking in when the output voltage of the forward converter is insufficient to overcome the grid line voltage.

2) The hybrid DC/DC converter topology in claim (1) where the power inputs of both forward and flyback DC/DC converters in claim (1) are connected in parallel and fed by a DC source, such as PV panels, wind mills, fuel cells or batteries.

3) The hybrid DC/DC converter topology in claim (1) where the power outputs of both forward and flyback DC/DC converters in claim (1) are connected in series to a DC voltage bus.

4) The hybrid DC/DC converter topology in claim (1) where the power outputs of both forward and flyback DC/DC converters in claim (1) are connected in parallel to a DC voltage bus.

5) The hybrid DC/DC converter topology in claim (1) where the voltage output of both forward and flyback DC/DC converters in claim (1) may be shaped to a specific waveform so that the following inverter circuit could be a line frequency inverter to improve power efficiency.

6) The hybrid DC/DC converter topology in claim (1) where the hybrid DC/DC converter is used in a solar/wind micro-inverter application.

7) The hybrid DC/DC converter topology in claim (1) where the hybrid DC/DC converter is used in a solar/wind string inverter application.

8) The hybrid DC/DC converter topology in claim (1) where the hybrid DC/DC converter is used in a solar/wind multiple string inverter application.

9) The hybrid DC/DC converter topology in claim (1) where the hybrid DC/DC converter is used in a solar/wind central inverter application.

10) The hybrid DC/DC converter topology in claim (1) where the hybrid DC/DC converter is used in a battery input inverter application.

11) The hybrid DC/DC converter topology in claim (1) where the hybrid DC/DC converter is used in a fuel cell inverter application.
